(19) United States
(12) Patent Application Publication
(10) Pub. No.: US 2024/0207873 A1
(43) Pub. Date: Jun. 27, 2024

(54) SPRAY APPARATUS FOR SPRAYING A COSMETIC LIQUID, METHOD FOR OPERATING A SPRAY APPARATUS, NOZZLE FOR A SPRAY APPARATUS AND NOZZLE ARRAY FOR A SPRAY APPARATUS

(71) Applicant: J. WAGNER GmbH, Markdorf (DE)

(72) Inventors: Sebastian MANGOLD, Salem (DE); Mujo TALETOVIC, Immenstaad (DE); Thomas R. JELTSCH, Friedrichshafen (DE); Alfred GÖHRING, Salem (DE); Manuel FIESEL, Überlingen (DE)

(21) Appl. No.: 18/555,366

(22) PCT Filed: Apr. 8, 2022
(86) PCT No.: PCT/EP2022/059399

§ 371 Date: Oct. 13, 2023

(30) Foreign Application Priority Data
Apr. 16, 2021 (DE) 10 2021 109 651.0

(51) Int. Cl. B05B 5/00; B05B 5/053; B05B 9/08

(52) U.S. Cl. CPC B05B 5/005; B05B 5/0533; B05B 9/085

(57) ABSTRACT

A spray apparatus for spraying a cosmetic liquid by way of electrostatic forces. The spray apparatus includes a fluid supply, at least one feed device, and at least one nozzle comprising a nozzle body, a connection flange, a nozzle channel, a spray opening, and an electrode. The fluid supply is connected to the feed device, the feed device is connected to the nozzle, and the electrode is arranged in the nozzle channel. The electrode is arranged in the nozzle channel such that it has a distance to the spray opening measured along a longitudinal axis of the nozzle channel of at most 2.1 mm and at least 0.0 mm.

### CROSS-REFERENCES TO RELATED APPLICATION

This Application is a Section 371 National Stage Application of International Application No. PCT/EP2022/059399, filed Apr. 8, 2022, and published as WO 2022/218848 A1 on Oct. 20, 2022, and claims priority to German Application No. 102021109651.0, filed Apr. 16, 2021; the contents of these applications are hereby incorporated by reference in their entirety.

### BRIEF DESCRIPTION OF THE DRAWINGS

FIG. 1 shows a schematic partial view of a first embodiment variant of a spray apparatus having a rod-shaped electrode in a sectional side view.

FIG. 2 shows a schematic partial view of a second embodiment variant of a spray apparatus having a tubular electrode in a sectional side view.

FIG. 3 shows a schematic partial view of a third embodiment variant of a spray apparatus having a contact body in a sectional side view.

FIGS. 4-6 show perspective partial views of a fourth embodiment variant of a spray apparatus having a contact body.

### DETAILED DESCRIPTION

The present disclosure relates to a spray apparatus for spraying a cosmetic liquid, to a method for operating a spray apparatus, to a nozzle for a spray apparatus, and to a nozzle array for a spray apparatus according to the preamble of claim 1, 10, 12, or 13, respectively.

A sprayer nozzle system for an electrodynamic sprayer is known from DE 10 2019 135 150 A1, in which the distance between an electrical contact element and a nozzle opening is between 5 mm and 20 mm.

It is an object of the present disclosure to propose a spray apparatus for spraying a cosmetic liquid, a method for operating a spray apparatus, a nozzle for a spray apparatus, and a nozzle array for a spray apparatus, in which the spraying of cosmetic liquid functions particularly reliably.

This object is achieved proceeding from the features of the preamble of claim 1 or 10 or 12 or 13 by the characterizing features of claim 1 or 10 or 12 or 13, respectively. Advantageous and expedient refinements are specified in the respective dependent claims.

The spray apparatus according to one example for spraying a cosmetic liquid by electrostatic forces comprises a fluid supply, at least one feed device, and at least one nozzle, wherein the nozzle comprises a nozzle body, a connection flange, a nozzle channel, a spray opening, and an electrode, wherein the fluid supply is connected to the feed device, wherein the feed device is connected to the nozzle, wherein the electrode is arranged in the nozzle channel, and wherein the electrode is arranged in the nozzle channel such that it has a distance to the spray opening, measured along a longitudinal axis of the nozzle channel, of at most 2.1 mm and at least 0.0 mm, in particular at least 0.1 mm, preferably at least 0.7 mm. It has been shown that spray apparatuses dimensioned in this way operate particularly reliably when spraying cosmetic liquids. Even an electrode lying in a plane with the spray opening does not represent a problem in view of examples described herein. A small distance, in particular extending up to 0.1 mm, preferably 0.7 mm, is preferred.

It is also provided that an operating voltage of at most 10 kV and in particular of approximately 7 kV to 8 kV is applied at the electrode in the operation of the spray apparatus. In this way, reliable operation is also promoted according to the experiments carried out.

Furthermore, it is provided that the spray apparatus is equipped with a safety device, by which the operating voltage is reduced to a safety voltage of at most 120 V direct current and preferably 0 V when a safety device detects a current flow of greater than 10 microamps and preferably greater than 4 microamps. Undesired operating states can be reliably avoided in this way.

It is also provided that in undisturbed spraying operation, an operating current of approximately 2 microamps flows. The spraying procedure may additionally be monitored and documented on the basis of the operating current in this way.

Furthermore, it is provided that the electrode is formed as a rod-shaped electrode which is arranged in the nozzle channel or the electrode is formed as a tubular electrode which is arranged in the nozzle channel, wherein in particular a lateral surface of the tubular electrode presses against an inner lateral surface of the nozzle channel. It has been empirically shown that reliable operation is also promoted by such elongated electrodes.

It is also provided that an end of the electrode lying opposite to the spray opening is formed flattened. It has been empirically shown that electrodes formed in this way, which end, for example, with a circular surface or a circular ring surface, also likewise promote reliable operation.

Furthermore, it is provided that the spray apparatus is operated using a power of at least 14 milliwatts and at most 100 milliwatts. In this way, the power consumption can be kept within limits with reliable operation at the same time.

It is provided that the cosmetic liquid is formed as an electrically insulating liquid and in particular as a liquid and electrically insulating cosmetic sunscreen product. It was possible to achieve particularly good results using such liquids in the experiment.

Finally, it is provided that the nozzle of the spray apparatus is equipped with a contact body, wherein the contact body encases a section of the electrode and is connected to a high-voltage feed line, wherein the contact body is formed from an electrically conductive synthetic polymer, preferably from an electrically conductive silicone, wherein it is provided in particular that the contact body forms a transition resistance between a contact point and the section of the electrode for providing a current flow for a shutdown sensor system, wherein it is provided in particular that the contact body is formed as a stopper, wherein it is provided in particular that the contact body forms the connection flange and is received in the nozzle body or that the contact body is received in the connection flange, wherein it is provided in particular that the high-voltage feed line is formed as a guide plate and the contact body is contacted by means of the guide plate, and wherein it is provided that the contact body is formed tapering conically toward the spray opening. It was possible to achieve particularly good results in experiments by equipping the spray apparatus with such a contact body.

In addition, it is possible due to the transition resistance between the contact point and the section of the electrode, for example, to obtain a current flow of 10 μA even at a high voltage of 7 kV, and thus to activate the shutdown sensor system. The transition resistance is thus to be less than/equal to 700 megaohms in order to cause at least a voltage drop of the 7 kV. At a preferred sensitivity of even 1% of the voltage of even 70 V voltage drop already, the transition resistance is even to be formed less than/equal to 7 megaohms. The corresponding method for using this possible embodiment will be described hereinafter. However, the method is not restricted here to the operating variables described in this section.

The method according to one example for operating a spray apparatus, which is designed in particular as claimed in at least one of claims 1 to 9, comprises the steps:
starting a spray operation by activating a fluid supply and applying an operating voltage of at most 10 kV and in particular of approximately 7 kV to 8 kV at an electrode;
monitoring the spray operation by means of a safety device, wherein the operating voltage is reduced by the safety device to a safety voltage of 120 V direct current and preferably 0 V when a current flow of greater than 10 microamps and preferably greater than 4 microamps is detected by the safety device. In this way, reliable operation is also promoted according to the experiments carried out and in this way undesired operating states can be reliably avoided.

Furthermore, it is provided in the method that the operating voltage is applied to the electrode again within milliseconds by the safety device after powering down to the safety voltage. Nearly uninterrupted operation can be implemented in this way for perception of the user.

The nozzle according to one example for a spray apparatus for spraying a cosmetic liquid, which is formed in particular as an electrically insulating liquid, by way of electrostatic forces comprises a nozzle body, a connection flange, a nozzle channel, a spray opening, and an electrode, wherein the electrode is arranged in the nozzle channel and wherein the electrode is arranged in the nozzle channel in such a way that it has a distance to the spray opening, measured along a longitudinal axis of the nozzle channel, of at most 2.1 mm and at least 0.0 mm, in particular at least 0.1 mm, preferably at least 0.7 mm. It has been shown that the spraying of cosmetic liquids can be implemented particularly reliably using such a nozzle. Even an electrode lying in a plane with the spray opening does not represent a problem in view of examples described herein. A small distance, in particular extending up to 0.1 mm, preferably 0.7 mm, is preferred.

The nozzle array according to one example for a spray apparatus for spraying a cosmetic liquid by electrostatic forces comprises at least three nozzles according to one example. It has been empirically shown that using such a nozzle array, the spraying of cosmetic liquids can be implemented particularly reliably and efficiently, especially on larger skin areas.

It is also provided that the longitudinal axes of the nozzle channels are aligned parallel to one another. Such an orientation of the nozzle channels facilitates the handling for a user since they can be able to be guided by instinct for the alignment of one of the nozzles.

Finally, the cosmetic liquid is formed as an electrically insulating liquid and in particular liquid and electrically insulating cosmetic sunscreen product. It was possible to achieve particularly good results in the experiment using such liquids.

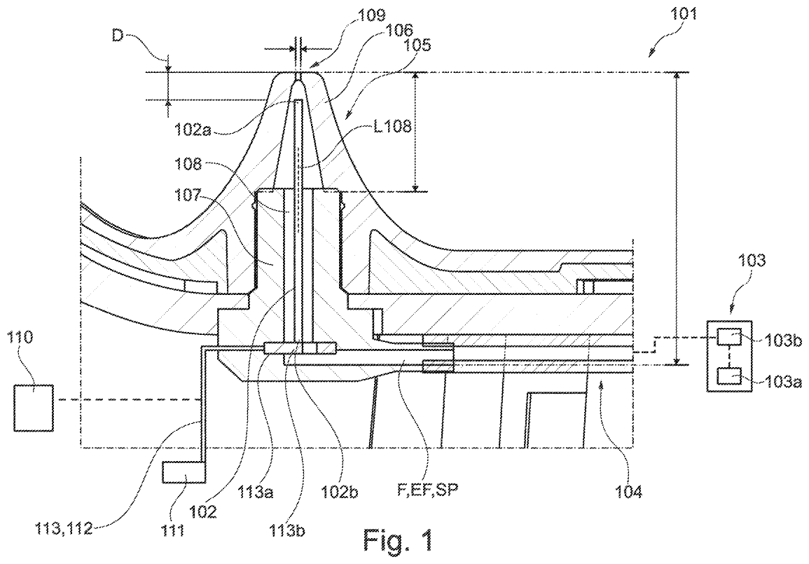

FIG. 1 shows a schematic partial view of a first embodiment variant of a spray apparatus 101 according to one example having a rod-shaped electrode 102 in a sectional side view. The spray apparatus 101 is designed for spraying a cosmetic liquid F by way of electrostatic forces and comprises a fluid supply 103 (only shown schematically), a feed device 104, and a nozzle 105. The fluid supply 103 comprises a tank 103a for the cosmetic liquid F and a pump 103b for conveying the cosmetic liquid F through the feed device 104 to the nozzle 105. The nozzle 105 comprises a nozzle body 106, a connection flange 107, a nozzle channel 108, a spray opening 109, and the electrode 102. The fluid supply 103 is connected to the feed device 104 and the feed device 104 is connected to the nozzle 105. The electrode 102 is arranged in the nozzle channel 108. In this case, the electrode 102 is arranged in the nozzle channel 108 such that it has a distance D of 1.5 mm to the spray opening 109, which distance is measured along a longitudinal axis L108 of the nozzle channel 108, wherein this distance can be up to 2.1 mm and at least 0.7 mm or less in embodiment variants of the spray apparatus.

An operating voltage of approximately 7.5 kV is applied at the electrode 102 in the operation of the spray apparatus 101. In embodiment variants, operation using up to 10 kV and at least approximately 7 kV is provided.

The spray apparatus 101 comprises a safety device 110, by which the operating voltage is reduced to a safety voltage of at most 120 V direct current when a safety device 110 detects a current flow of greater than 10 microamps. According to embodiment variants, a safety voltage of 0 V can also be provided and a current flow of greater than 4 microamps can also already be provided as a limiting value for a reduction of the operating voltage to the safety voltage. In the spray apparatus 101, an operating current of approximately 2 microamps flows in undisturbed spraying operation.

The rod-shaped electrode 102 is arranged centrally in the nozzle channel 108. In this case, the nozzle channel 108 passes through the connection flange 107 and the nozzle body 106 and opens into the spray opening 109 formed in the nozzle body 106. An end 102a of the electrode 102 opposite to the spray opening 109 in the nozzle channel 108 is formed planar in the form of a circular disk. According to one embodiment variant, a planar formation in the form of a polygonal surface is also provided.

A high-voltage feed line 112 coming from a high-voltage source 111 is embodied as a guide plate 113, to which the electrode 102 is connected with a second end 102b opposite to the first end 102a. In this case, the guide plate 113 comprises, in the area of the nozzle channel 108, a ring-like contact 113a having a web 113b leading to the electrode 102.

The spray apparatus 101 is operated using a power of at least 14 milliwatts and at most 100 milliwatts. For this purpose, the power is selected in each case matching with the liquid F to be sprayed and matching with the application and matching with the number of nozzles. The spray apparatus 101 shown in FIG. 1 can—as shown—be equipped with the one nozzle 105 and alternatively also with further nozzles, wherein these are then constructed comparably to the illustrated nozzle and multiple nozzles form a nozzle array.

The cosmetic liquid F is an electrically insulating liquid EF and is formed as a liquid and electrically insulating cosmetic sunscreen product SP.

The operation of the spray apparatus 101 runs as follows:
starting a spray operation by activating the fluid supply 103 and applying the operating voltage at the electrode 102;
monitoring the spray operation by means of the safety device 110, wherein the operating voltage is reduced to a safety voltage of at most 120 V direct current by the safety device 110 when a current flow of greater than 10 microamps is detected by the safety device 110;
reapplying the operating voltage to the electrode 102 when the operating voltage was previously powered down to the safety voltage within milliseconds by the safety device 110.

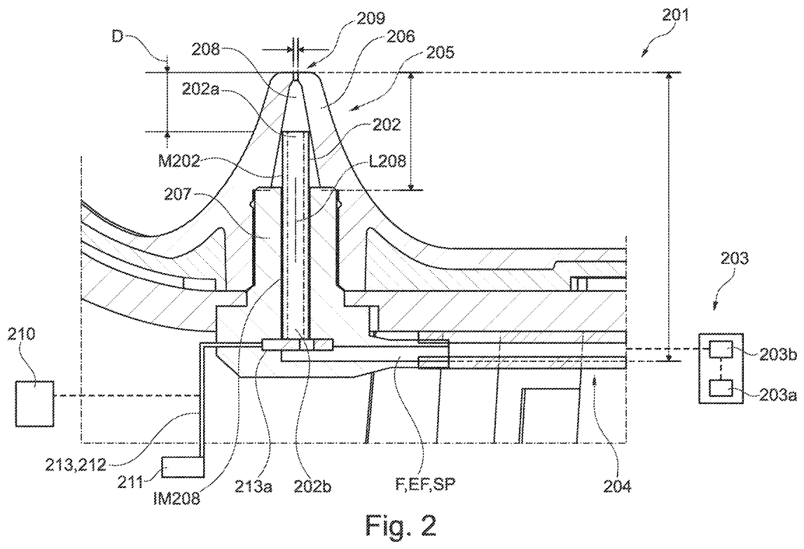

FIG. 2 shows a schematic partial view of a second embodiment variant of a spray apparatus 201 according to one example in a sectional side view. In principle, reference can be made here to the statements on FIG. 1 and the first embodiment variant shown there. In contrast thereto, the spray apparatus 201 comprises a nozzle 205 having a tubular electrode 202 and not having a rod-shaped electrode.

The spray apparatus 201 is designed for spraying a cosmetic liquid F by way of electrostatic forces and comprises a fluid supply 203 (shown solely schematically), a feed device 204, and the nozzle 205. The fluid supply 203 comprises a tank 203a for the cosmetic liquid F and a pump 203b for conveying the cosmetic liquid F through the feed device 204 to the nozzle 205. The nozzle 205 comprises a nozzle body 206, a connection flange 207, a nozzle channel 208, a spray opening 209, and the electrode 202. The fluid supply 203 is connected to the feed device 204 and the feed device 204 is connected to the nozzle 205. The electrode 202 is arranged in the nozzle channel 208. The electrode 202 is arranged in this case in the nozzle channel 208 such that it has a distance D of 1.5 mm to the spray opening 209, which distance is measured along a longitudinal axis L208 of the nozzle channel 208, wherein this distance can be up to 2.1 mm and at least 0.7 mm or less in embodiment variants of the spray apparatus.

The tubular electrode 202 is arranged centrally in the nozzle channel 208 and presses with a lateral surface M202 against an inner lateral surface IM208 of the nozzle channel 208. In this case, the nozzle channel 208 passes through the connection flange 207 and the nozzle body 206 and opens into the spray opening 209 formed in the nozzle body 206. An end 202a of the electrode 202 opposite to the spray opening 209 in the nozzle channel 208 is formed planar in the form of a circular ring disk.

A high voltage feed line 212 coming from a high-voltage source 211 is embodied as a guide plate 213, using which the electrode 202 is connected to a second end 202b opposite to the first end 202a. In this case, the guide plate 213 comprises a ring-like contact 213a in the area of the nozzle channel 208.

The spray apparatus 201 is operated using a power of at least 14 milliwatts and at most 100 milliwatts. For this purpose, the power is selected in each case matching with the liquid F to be sprayed and matching with the application and matching with the number of the nozzles. The spray apparatus 201 shown in FIG. 2 can—as shown—be equipped with the one nozzle 205 and alternatively also with further nozzles, wherein these are then constructed comparably to the illustrated nozzle and form a nozzle array. Like the first embodiment variant, the second embodiment variant also comprises a safety device 210.

The cosmetic liquid F is an electrically insulating liquid EF and is formed as a liquid and electrically insulating cosmetic sunscreen product SP.

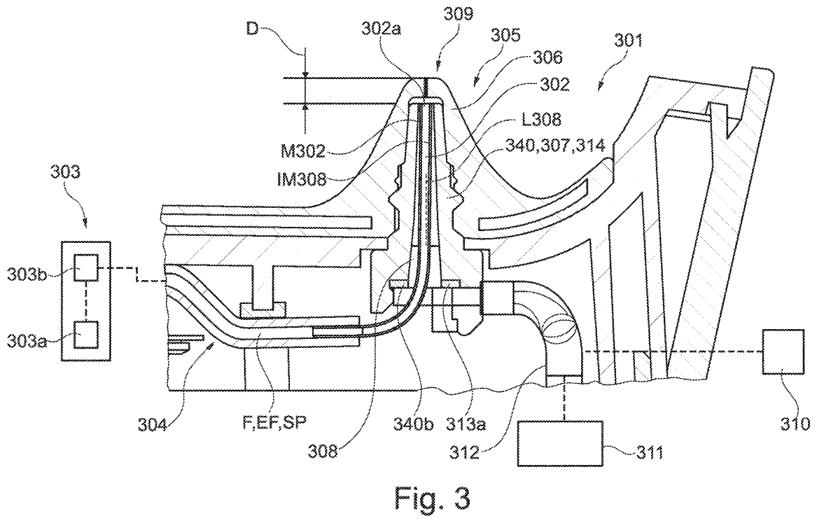

FIG. 3 shows a schematic partial view of a third embodiment variant of a spray apparatus 301 according to one example having a nozzle 305, which comprises a contact body 340, in a sectional side view.

As in the second embodiment variant shown in FIG. 2, an electrode is formed as a tubular electrode 302. In contrast thereto, the electrode 302, however, is not contacted by means of a ring-like contact, but rather by means of the contact body 340, which also forms a connection flange 307 and is received in a nozzle body 306. The contact body 340 encases the tubular electrode 302 up to a first end 302a, with which said electrode is opposite to a spray opening 309 of the nozzle 305.

The spray apparatus 301 is designed for spraying a cosmetic liquid F by way of electrostatic forces and comprises a fluid supply 303 (solely shown schematically), a feed device 304, and the nozzle 305. The fluid supply 303 comprises a tank 303a for the cosmetic liquid F and a pump 303b for conveying the cosmetic liquid F through the feed device 304 to the nozzle 305. The nozzle 305 comprises the nozzle body 306, the connection flange 307 formed by the contact body 340, a nozzle channel 308, the spray opening 309, and the electrode 302. The fluid supply 303 is connected to the feed device 304 and the feed device 304 is connected to the nozzle 305. The electrode 302 is arranged in the nozzle channel 308. In this case, the nozzle channel 308 is essentially formed by the contact body 340. The tubular electrode 302 is arranged in the nozzle channel 308 such that it has a distance D of 1.5 mm to the spray opening 309, which distance is measured along a longitudinal axis L308 of the nozzle channel 308, wherein this distance can be up to 2.1 mm and at least 0.7 mm or less in embodiment variants of the spray apparatus.

The tubular electrode 302 is arranged centrally in the nozzle channel 308 and presses with a lateral surface M302 against an inner lateral surface IM308 of the nozzle channel 308. In this case, the nozzle channel 308 passes through the connection flange 307 formed by the contact body 340 and the nozzle body 306 and opens into the spray opening 309 formed in the nozzle body 306. The end 302a of the electrode 302 opposite to the spray opening 309 in the nozzle channel 308 is formed planar in the form of a circular ring disk.

A high-voltage feed line 312 coming from a high-voltage source 311 is connected via a ring-like contact 313a at a base 340b of the contact body 340, which is formed as a sleeve-like stopper 341. The contact body 340 is formed conically tapering toward the spray opening 309.

The spray apparatus 301 is operated using a power of at least 14 milliwatts and at most 100 milliwatts. In this case, the power is selected in each case matching with the liquid F to be sprayed and matching with the application and matching with the number of nozzles. The spray apparatus 301 shown in FIG. 3 can—as shown—be equipped with the one nozzle 305 and alternatively also with further nozzles, wherein these are then constructed comparably to the illustrated nozzle. Multiple nozzles then form a nozzle array. Like the first and the second embodiment variant, the third embodiment variant also comprises a safety device 310.

The cosmetic liquid F is an electrically insulating liquid EF and is formed as a liquid and electrically insulating cosmetic sunscreen product SP.

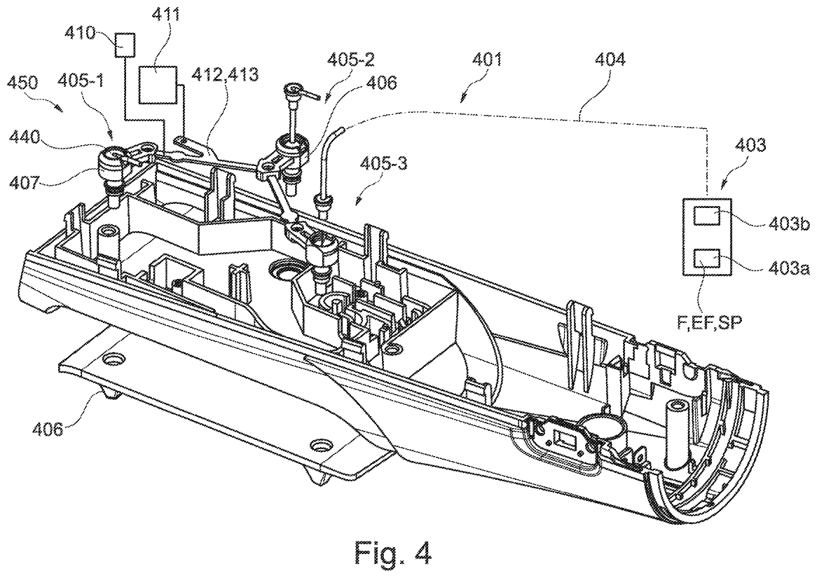

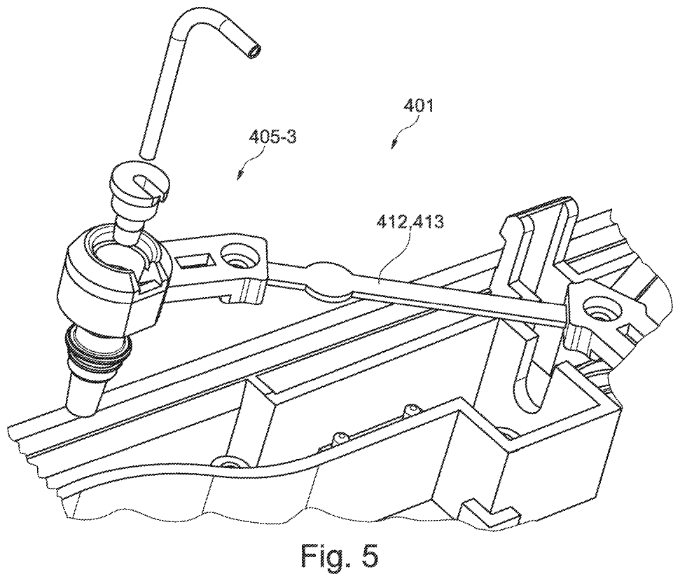

FIGS. 4 to 6 show perspective partial views of a fourth embodiment variant of a spray apparatus 401 according to one example having a contact body 440. In this case, FIGS. 4 and 5 are embodied as exploded views. The fourth embodiment variant of the spray apparatus 401 comprises three nozzles 405-1, 405-2, and 405-3, wherein the three nozzles 405-1, 405-2, and 405-3 form a nozzle array 450 and wherein the first nozzle 405-1 is described in more detail by way of example hereinafter.

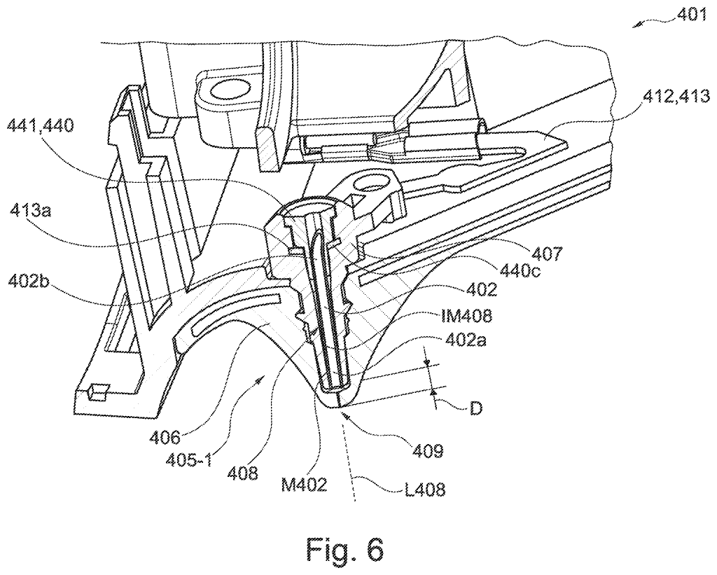

As in the second embodiment variant shown in FIG. 2 and in the third embodiment variant shown in FIG. 3, an electrode 402 (see FIG. 6) of the first nozzle 405-1 of the fourth embodiment variant is formed as a tubular electrode 402. Similarly as in the third embodiment variant, the electrode 402 is contacted by means of the contact body 440. In contrast to the third embodiment variant, the contact body 440 is not received by a nozzle body, but rather is received by a connection flange 407. The contact body 440 encases the tubular electrode 402 in the area of a second end 402b, which is opposite to a first end 402a, at which the electrode 402 is opposite to a spray opening 409 of the first nozzle 405-1.

The spray apparatus 401 is designed for spraying a cosmetic liquid F by way of electrostatic forces and comprises a fluid supply 403 (only schematically shown in FIG. 4), a feed device 404 (only shown by way of example and schematically in FIG. 4 and only for the third nozzle 405-3), and the mentioned three nozzles 405-1, 405-2, and 405-3. The fluid supply 403 comprises a tank 403a for the cosmetic liquid F and a pump 403b for conveying the cosmetic liquid F through the feed device 404 to the nozzles 405-1, 405-2, and 405-3. The nozzle 405-1 comprises the nozzle body 406, the connection flange 407, the contact body 440, a nozzle channel 408, the spray opening 409, and the electrode 402. The fluid supply 403 is connected to the feed device 404 and the feed device 404 is connected to the nozzles 405-1, 405-2, and 405-3. The electrode 402 is arranged in the nozzle channel 408. In this case, the nozzle channel 408 is formed in a lower third remote from the spray opening 409 by the contact body 440 and is formed in the two upper thirds by the connection flange 407 and the nozzle body 406. The electrode 402 is arranged in the nozzle channel 408 such that it has a distance D of 1.5 mm to the spray opening 409, which distance is measured along a longitudinal axis L408 of the nozzle channel 408, wherein this distance can be up to 2.1 mm and at least 0.7 mm or less in embodiment variants of the spray apparatus.

The tubular electrode 402 is arranged centrally in the nozzle channel 408 and presses with a lateral surface M402 in the area of the contact body 440 and in an area of the connection flange 407 close to the spray opening 409 against an inner lateral surface IM408 of the nozzle channel 408. In this case, the nozzle channel 408 passes through the contact body 440, the connection flange 407, and the nozzle body 406 and opens into the spray opening 409 formed in the nozzle body 406. The end 402a of the electrode 402 opposite to the spray opening 409 in the nozzle channel 408 is formed planar in the form of a circular ring disk.

A high-voltage feed line 412 coming from a high voltage source 411 (only shown in FIG. 4), which is formed as a guide plate 413, is connected via a ring-like contact 413a at a shoulder 440c of the contact body 440 formed as a sleeve-like stopper 441. The contact body 440 is formed conically tapering toward the spray opening 409. The contact bodies of the second nozzle 405-2 and the third nozzle 405-3 are also contacted via the guide plate 413.

The spray apparatus 401 is operated using a power of at least 14 milliwatts and at most 100 milliwatts. In this case, the power is selected in each case matching with the liquid F to be sprayed and matching with the application and matching with the number of nozzles. The spray apparatus 401 shown in FIGS. 4 to 6 can be equipped as shown with the three nozzles 405-1, 405-2, and 405-3 and alternatively also with further nozzles or only two nozzles or only one nozzle.

Like the first, the second, and the third embodiment variant, the fourth embodiment variant—as exclusively shown in FIG. 4—also comprises a safety device 410 (only schematically shown).

The cosmetic liquid F is an electrically insulating liquid EF and is formed as a liquid and electrically insulating cosmetic sunscreen product SP.

Although the present invention has been described with reference to preferred embodiments, workers skilled in the art will recognize that changes may be made in form and detail without departing from the spirit and scope of the invention.

### LIST OF REFERENCE SIGNS

101 spray apparatus
102 rod-shaped electrode
102a first end of 102
102b second end of 102
103 fluid supply
103a tank of 103
103b pump of 103
104 feed device
105 nozzle
106 nozzle body of 105
107 connection flange of 105
108 nozzle channel of 105
109 spray opening of 105
110 safety device
111 high-voltage source
112 high-voltage feed line 111
113 guide plate
113a ring-like contact of 113
113b web of 113
201 spray apparatus
202 tubular electrode
202a first end of 202
202b second end of 202
203 fluid supply
203a tank of 203
203b pump of 203
204 feed device
205 nozzle
206 nozzle body of 205
207 connection flange of 205
208 nozzle channel of 205
209 spray opening of 205
210 safety device
211 high-voltage source
212 high-voltage feed line 211
213 guide plate
213a ring-like contact of 213
301 spray apparatus
302 tubular electrode
302a first end of 302
303 fluid supply
303a tank of 303
303b pump of 303
304 feed device
305 nozzle
306 nozzle body of 305
307 connection flange of 305
308 nozzle channel of 305
309 spray opening of 305
310 safety device
311 high-voltage source
312 high-voltage feed line 311
313a ring-like contact of 313
340 contact body
340b base of 340
341 sleeve-like stopper
401 spray apparatus
402 tubular electrode
402a first end of 402
402b second end of 402
403 fluid supply
403a tank of 403
403b pump of 403
404 feed device
405-1 first nozzle
405-2 second nozzle
405-3 third nozzle
406 nozzle body of 405
407 connection flange of 405
408 nozzle channel of 405
409 spray opening of 405
410 safety device
411 high-voltage source
412 high-voltage feed line 411
413 guide plate
413a ring-like contact of 413
440 contact body
440c shoulder of 440
441 sleeve-like stopper
450 nozzle array
D distance between 102 and 109 or 202 and 209 or 302 and 309 or 402 and 409
EF electrically insulating liquid
F cosmetic liquid
IM208 inner lateral surface of 208
IM308 inner lateral surface of 308
IM408 inner lateral surface of 408
L108 longitudinal axis of 108
L208 longitudinal axis of 208
L308 longitudinal axis of 308
L408 longitudinal axis of 308
M202 lateral surface of 202
M302 lateral surface of 302
M402 lateral surface of 402
SP sunscreen product

1. A spray apparatus for spraying a cosmetic liquid by way of electrostatic forces, comprising:
a fluid supply,
at least one feed device,
at least one nozzle,
wherein the at least one nozzle comprises a nozzle body, a connection flange, a nozzle channel, a spray opening, and an electrode,
wherein the fluid supply is connected to the at least one feed device,
wherein the least one feed device is connected to the at least one nozzle,
wherein the electrode is arranged in the nozzle channel such that the electrode has a distance to the spray opening measured along a longitudinal axis of the nozzle channel of at most 2.1 mm and at least 0.0 mm.

2. The spray apparatus as claimed in claim 1, wherein an operating voltage of approximately 7 kV to 8 kV is applied at the electrode in the operation of the spray apparatus.

3. The spray apparatus as claimed in claim 1, wherein the spray apparatus comprises a safety device, by which an operating voltage is reduced to a safety voltage of at most 120 V direct current when a safety device detects a current flow of greater than 10 microamps.

4. The spray apparatus as claimed in claim 1, wherein in undisturbed spraying operation, an operating current of approximately 2 microamps flows.

5. The spray apparatus as claimed in claim 1, wherein at least one of:
the electrode is formed as a rod-shaped electrode, which is arranged in the nozzle channel, or
the electrode is formed as a tubular electrode which is arranged in the nozzle channel, wherein the tubular electrode comprises a lateral surface, and presses against an inner lateral surface of the nozzle channel.

6. The spray apparatus as claimed in claim 1, wherein an end of the electrode opposite to the spray opening is formed planar.

7. The spray apparatus as claimed in claim 1, wherein the spray apparatus operates using a power of at least 14 milliwatts and at most 100 milliwatts.

8. The spray apparatus as claimed in claim 1, wherein the cosmetic liquid is a liquid and electrically insulating cosmetic sunscreen product.

9. The spray apparatus as claimed in claim 1, wherein
the at least one nozzle comprises a contact body,
wherein the contact body encases a section of the electrode and is connected to a high-voltage feed line,
wherein the contact body is made of an electrically conductive synthetic polymer,
the contact body forms a transition resistance between a contact point and the section of the electrode for providing a current flow for a shutdown sensor system,
the contact body is formed as a stopper,
that the contact body forms the connection flange and is received in the nozzle body or that the contact body is received in the connection flange,
the high-voltage feed line is formed as a guide plate and the contact body is contacted by means of the guide plate, and
the contact body is formed conically tapering toward the spray opening.

10. A method for operating a spray apparatus, which is designed as claimed in claim 1, comprising the steps:
starting a spray operation by activating a fluid supply and applying an operating voltage of approximately 7 kV to 8 kV at an electrode;
monitoring the spray operation by means of a safety device,
wherein the operating voltage is reduced to a safety voltage of 120 V direct current and preferably 0 V by the safety device when a current flow of greater than 10 microamps is detected by the safety device.

11. The method as claimed in claim 10, wherein the operating voltage is applied at the electrode again within milliseconds by the safety device after powering down to the safety voltage.

12. A nozzle for a spray apparatus for spraying a cosmetic liquid, which is formed as an electrically insulating liquid, by way of electrostatic forces comprising:
a nozzle body,
a connection flange,
a nozzle channel,
a spray opening, and
an electrode,
wherein
the electrode is arranged in the nozzle channel,
the electrode is arranged in the nozzle channel such that the electrode has a distance to the spray opening measured along a longitudinal axis of the nozzle channel of at most 2.1 mm and at least 0.0 mm.

13. A nozzle array for a spray apparatus for spraying a cosmetic liquid by way of electrostatic forces, wherein the nozzle array comprises at least three nozzles as claimed in claim 12.

14. The nozzle array as claimed in claim 13, wherein the longitudinal axes of the nozzle channels are aligned parallel to one another.

15. The nozzle array as claimed in claim 14, wherein the cosmetic liquid is a liquid and electrically insulating cosmetic sunscreen product.

16. The spray apparatus as claimed in claim 1, wherein the distance to the spray opening is at least 0.1 mm.

17. The spray apparatus as claimed in claim 16, wherein the distance to the spray opening is at least 0.7 mm.

18. The nozzle as claimed in claim 12, wherein the distance to the spray opening is at least 0.1 mm.

19. The nozzle as claimed in claim 18, wherein the distance to the spray opening is at least 0.7 mm.
